(19) United States
(12) Patent Application Publication
(10) Pub. No.: US 2014/0325143 A1
(43) Pub. Date: Oct. 30, 2014

(54) USING PROTECTION INFORMATION METADATA FIELDS FOR STORING CONFIGURATION INFORMATION

(71) Applicant: LSI CORPORATION, (US)

(72) Inventor: Allen B. Kelton, Colorado Springs, CO (US)

(21) Appl. No.: 13/889,421

(22) Filed: May 8, 2013

Related U.S. Application Data
(60) Provisional application No. 61/816,082, filed on Apr. 25, 2013.

(51) Int. Cl. G06F 3/06

(52) U.S. Cl. CPC G06F 3/0659; G06F 3/0604; G06F 3/0689
USPC 711/114; 711/154

(57) ABSTRACT

A SCSI command is issued to a mass storage device to read a first block that stores a first portion of a DDF data structure associated with a first volume. The SCSI command instructs the mass storage device not to check at least a first portion of protection information metadata associated with the first block. In response to the SCSI command, a host receives configuration information encoded into the protection information metadata. The host decodes the configuration information encoded into the protection information metadata to determine a first property associated with the first volume.

### BACKGROUND

Mass storage systems continue to provide increased storage capacities to satisfy user demands. Photo and movie storage, and photo and movie sharing are examples of applications that fuel the growth in demand for larger and larger storage systems.

A solution to these increasing demands is the use of arrays of multiple inexpensive disks. These arrays may be configured in ways that provide redundancy and error recovery without any loss of data. These arrays may also be configured to increase read and write performance by allowing data to be read or written simultaneously to multiple disk drives. These arrays may also be configured to allow “hot-swapping” which allows a failed disk to be replaced without interrupting the storage services of the array. Whether or not any redundancy is provided, these arrays are commonly referred to as redundant arrays of independent disks (or more commonly by the acronym RAID).

RAID storage systems typically utilize a controller that shields the user or host system from the details of managing the storage array. The controller makes the storage array appear as one or more disk drives (or volumes). This is accomplished in spite of the fact that the data (or redundant data) for a particular volume may be spread across multiple disk drives.

SCSI/T-10 Protection Information (PI) provides a method to write 8 bytes of metadata with a logical data block to provide additional information related to the history of the block. It is a standard method to provide end-to-end data protection (EEDP). EEDP's goal is to provide assurance that the returned data is from the logical block that the data was original written to and has not been corrupted.

### SUMMARY

An embodiment of the invention may therefore comprise a method of using information stored in protection information fields of mass storage device blocks that store data disk format (DDF) data structures. This method may comprise issuing a SCSI command to the mass storage device to read a first block that stores a first portion of a DDF data structure associated with at least a first volume. The SCSI command instructs the mass storage device not to check at least a first portion of protection information metadata associated with the first block. In response to the SCSI command, configuration information encoded into the protection information metadata is received. The configuration information that was encoded into the protection information metadata is decoded to determine at least a first property associated with the at least first volume.

An embodiment of the invention may therefore further comprise a method of detecting protection information. This method may comprise sending a 32-byte SCSI command to a mass storage device. The SCSI command has parameters that instruct the mass storage device to read a block associated with a data disk format data structure. The parameters also instruct the mass storage device not to check a first protection information metadata field and a second protection information metadata field. The data disk format (DDF) data structure describes how data is formatted across a plurality of disks in a RAID group. In response to the SCSI command configuration information is received. This configuration information was stored in at least one of the first protection information metadata field and the second protection information metadata field.

### BRIEF DESCRIPTION OF THE FIGURES

FIG. 1 is a block diagram illustrating a storage system.

FIG. 2 is a diagram illustrating protection information fields and an example of encoded configuration information fields.

FIG. 3 is a flowchart illustrating a method of using information stored in protection information fields.

FIG. 4 is a flowchart illustrating a method of detecting protection information.

FIG. 5 is a block diagram of a computer system.

### DETAILED DESCRIPTION OF THE EMBODIMENTS

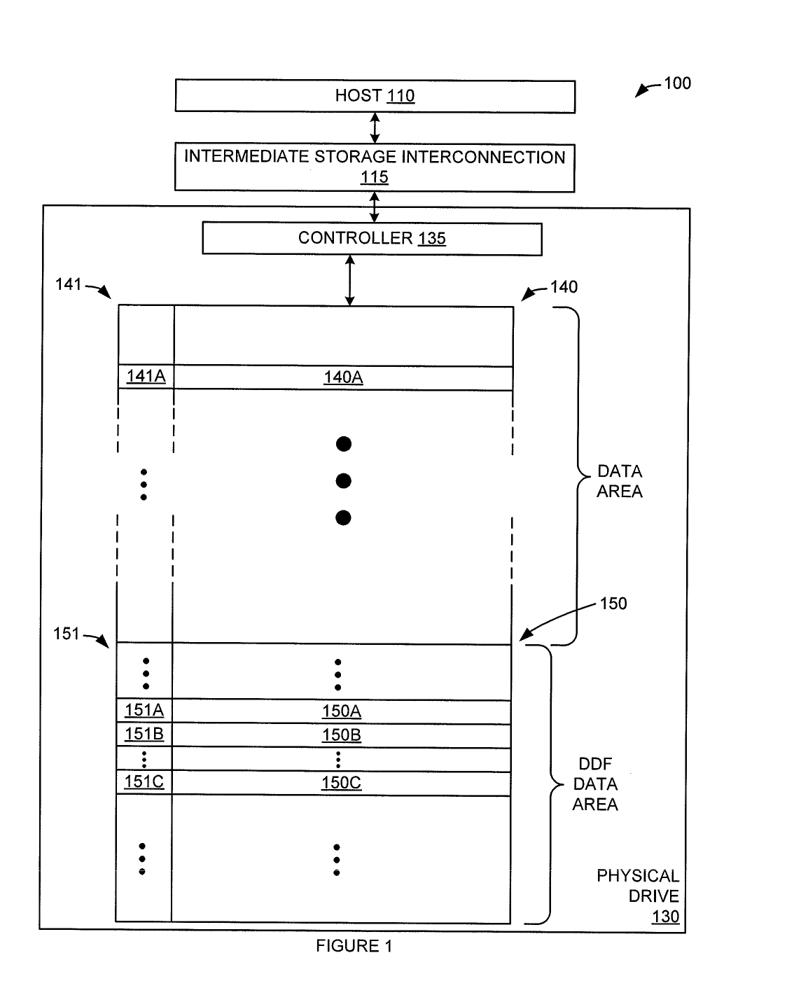

FIG. 1 is a block diagram illustrating a storage system. Storage system 100 comprises host 110, intermediate storage interconnection 115, and physical drive 130. Physical drive 130 may include controller 135, data area 140, data area protection information 141, DDF data area 150, and DDF protection information area 151. Host 110 is operatively coupled to intermediate storage interconnection 115. Intermediate storage interconnection 115 is operatively coupled to physical drive 130, and controller 135, in particular.

In an embodiment, storage system 100 reads and/or writes data on physical disk 130 from/to two areas: a user data area and a disk data format (DDF) data area. Both of these areas have associated protection information that is also stored on physical disk 130. The format, contents, and location of the DDF data area are detailed in the COMMON RAID DISK DATA FORMAT SPECIFICATION, Revision 1.2, Jul. 28, 2006 available at www.snia.org which is hereby incorporated herein by reference for all purposes.

In an embodiment, storage system 100 implements end-to-end data protection (EEDP). EEDP can include error detection over cover the entire path from host 110 to the physical drive media (i.e., data area 140, data area protection information 141, DDF data area 150, and DDF protection information area 151) and back. Data protection information for data area 140 is stored in data protection information area 141. Data protection information for DDF data area 150 is stored in DDF protection information area 151. Both sets of protection information can stay with their respective data from physical drive 130 through intermediate interconnection 115 (e.g., Fibre Channel or SAS connections), through RAID controllers, and through drive electronics (e.g., controller 135) to the physical drive 130 media. When read, the same data protection information returns with the data to host 110. The protection information may be used to verify the correctness of the data at multiple points in the path from the media of physical drive 130 to host 110.

The protection information may be implemented using eight bytes of data appended to (and/or associated with) each data block stored on the media of physical drive 130. These eight bytes may be divided into three fields: (1) the guard, (2) the reference tag, and, (3) the application tag. The protection data is created by host 110, transmitted with data blocks, and written to the media of physical drive 130. The guard field protects against errors in the data. The two-byte guard field is a Cyclic Redundancy Check (CRC) on the data in the data block. This allows each device along the path from media of physical drive 130 to host 110 (and back) to check that the data in the block is still correct. Host 110 uses the CRC algorithm specified by the SCSI/T-10 protection specification to fill the guard fields written to data protection information area 141 when sending a write data command destined for blocks in data area 140. Because a standard CRC algorithm is used, physical drive 130, and controller 135 in particular, can check that the data is correct before writing it to the media of physical drive 130.

On a read command, physical drive 130 drive reads the protection information from data protection information area 141, checks it, and then sends the protection information along with the data. When a block of data is received by the host 110, the user data block can be checked against guard field to verify that the data was received correctly.

The four-byte reference tag written into data protection information area 141 contains block address information. As data is moved from host 110 to the media of physical drive 130 and back (perhaps through intermediate storage interconnection 115 and/or intermediate devices, such as a RAID controller), there is a possibility of an addressing error. An addressing error causes the wrong blocks of correct data to be sent, or blocks to be sent in the wrong order. The reference tag numbers the blocks so physical drive 130, host 110, and/or parts of intermediate storage interconnection 115 can check to determine whether the correct data blocks were received in the proper order.

The two-byte application tag may be used by storage applications to add additional checking information to each data block in data area 140. A typical use for the application tag is to associate RAID configuration data with data blocks in data area 140. An application tag may be created by the application and checked by the application. The application tag may also be checked by physical drive 130. Because the Guard, Reference Tag and Application Tag are created with a standard algorithm for data blocks associated with data area 140 (and the associated protection information stored in data protection information area 141) physical drives 130 can check the received data and report errors when data is being written and read back.

Four types of protection may be defined: (a) Type-0—No protection; (b) Type-1—protection is enabled and the 32-byte commands are not valid; (c) Type 2—Protection is enabled and only the 32-byte commands are valid; and, (d) Type-3—Protection is enabled and the 32-byte commands are not valid. For Type-3 protection, the reference tag is not defined and may be used as an extension of the application tag. Physical drive 130 will not check the reference tag when using Type-3 protection.

The type of protection determines which read, write and verify commands are enabled and how the reference tag is used. The read, write and verify commands can be roughly broken into two groups: the 32-byte commands and the non-32-byte commands. The non-32-byte commands are the family of commonly used read, write and verify commands (10-, 12-, 16-byte commands, XOR 32-byte commands). For the full list, see AMERICAN NATIONAL STANDARD T10/1799-D INFORMATION TECHNOLOGY—SCSI BLOCK COMMANDS-3 (SBC-3) Revision 25, Oct. 27, 2010, available from www.t10.org (incorporated by reference herein for all purposes). In the non-32-byte commands, the reference tag is the low-order bytes of the Logical Block Address (LBA). Because the non-32-byte commands do not contain an expected application tag value, the application tag is not checked by physical drive 130.

The 32-byte commands, (i.e., Read(32), Verify(32), Write(32), Write and Verify(32) and Write Same(32)) have additional fields that allow finer control over protection information checking. The 32-byte commands specify the starting value for checking the reference tag. The 32-byte commands also specify the value to use for checking the application tag. All of the commands used with protection information contain a protect field (e.g., RDPROTECT, WRPROTECT or ORPROTECT) that specifies which protection fields are checked by physical drive 130 for that command.

Type-2 protection information is used with 32-byte SCSI commands to perform I/O that includes protection information. This allows the application tag and initial reference tag values to be designated. This also provides a method to designate which of the protection information fields (i.e., guard, application, and/or reference) will be checked by physical drive 130 or other hardware. Physical drive 130 will still perform I/O for writes other than the 32-byte format (legacy commands), but the application and reference Tags will be written with 1's in all bits, and the guard field will contain either 1's or the CRC of the user data. Legacy commands can be used for reads, and only the guard field will be checked if the DPICZ bit (defined in SBC-3) is clear and any bit in the other fields is not a 1.

By using a value of 011b (i.e., shall not check guard, application tag, and reference tag) for the 3-bits of RDPROTECT, WRPROTECT, ORPROTECT, or VRPROTECT, the physical drive 130 will not check the values of the protection information metadata fields for consistency. A value of 100b (i.e., shall check guard; shall not check application tag, and reference tag) for the 3-bits of RDPROTECT, WRPROTECT, ORPROTECT, or VRPROTECT, will instruct physical drive 130 to only check the guard field. By using one of these sets of values, the 8 bytes of protection information metadata is transferred along with user data.

In an embodiment, the unchecked protection information metadata fields can be rededicated to non-standard configuration information instead of the EEDP use. This allows the DDF data area 150 to contain standard DDF data while the DDF protection information area 151 stores configuration information.

In an embodiment, the configuration information stored in the DDF protection information area 151 can be used to designate whether the protection information is in use, and how the application and reference tags are used. For example, the protection information fields in the DDF protection information area 151 can be used to designate that a logical volume associated with the DDF data structure associated with a block has protection information, that the reference tag is used to hold the lower 32-bits of the corresponding logical volume's logical block address (LBA), and that the application tag contains the logical volume ID for physical drive 130's LBA, the protection information fields for the parity blocks are the XOR of the protection information fields of the data blocks, and the logical volume is presented to host 110 as a Type-1 protection information device. Other encodings may be used and can co-exist. For example, encodings can be used to indicate that the application tag is unused or designated by host 110, that the reference tag contains the lower 32-bits of physical drive 130's LBA, and that the logical volume is presented to the host 110 as Type-0 (i.e., non-protection information devices).

If physical drive 130 does not support the non-volatile setting of the DPICZ bit, the value 100b should be used for the 3-bits of RDPROTECT, WRPROTECT, ORPROTECT, and VRPROTECT so that legacy commands will not encounter errors in the guard field, and only the reference and application tags can be used for encoding configuration information. If the DPICZ can be set, the value 011b can be used for the 3-bits of RDPROTECT, WRPROTECT, ORPROTECT, and VRPROTECT for transactions to/from DDF data area 150. This allows the two bytes of guard field metadata per logical block to be used for configuration information.

In an embodiment, when a logical volume is imported into a storage system without protection information awareness, a controller in that system will issue legacy reads. The non-standard configuration information stored in the DDF protection information area 151 will not be transferred to the non-protection information aware controller. Thus, the non-protection information aware controller will process the information stored only in DDF data area 150. As part of the import process, the non-protection information aware controller will rewrite the DDF records in DDF data area 150 with the appropriate updated DDF configuration data structures and information. This update will be performed with legacy writes, which will overwrite the reference and application tag fields in DDF protection information area 151 with 1's. Since non-protection information aware controller never used DDF protection information area 151, it will be unaffected by the loss of the information previously encoded within DDF protection information area 151 by a protection information aware controller.

When DDF configuration information and data structures stored in DDF data area 150 is read by a controller that supports protection information, it will use protect values that instruct the physical drive 130 not to perform checking on the protection information fields stored in DDF protection information area 151. If the information stored in the protection information fields of DDF protection information area 151 is consistent, the controller can provide the protection information features specified for the logical volumes. If the information is not consistent, such as when the logical volume came from a product that encoded new, unknown features in the DDF protection information area 151, or had been imported into a non-protection information aware controller, the protection information features can be disable on the logical volumes.

Any method could be used to encode the data in the repurposed protection information fields stored in DDF protection information area 151. The protection information fields associated with any or all of the DDF data structures (i.e., blocks storing those DDF data structures) can be combined into one or more data structures, or encoding can be functionally based so that the protection information fields stored in DDF protection information area 151 relate to the DDF data structure or record they are associated with.

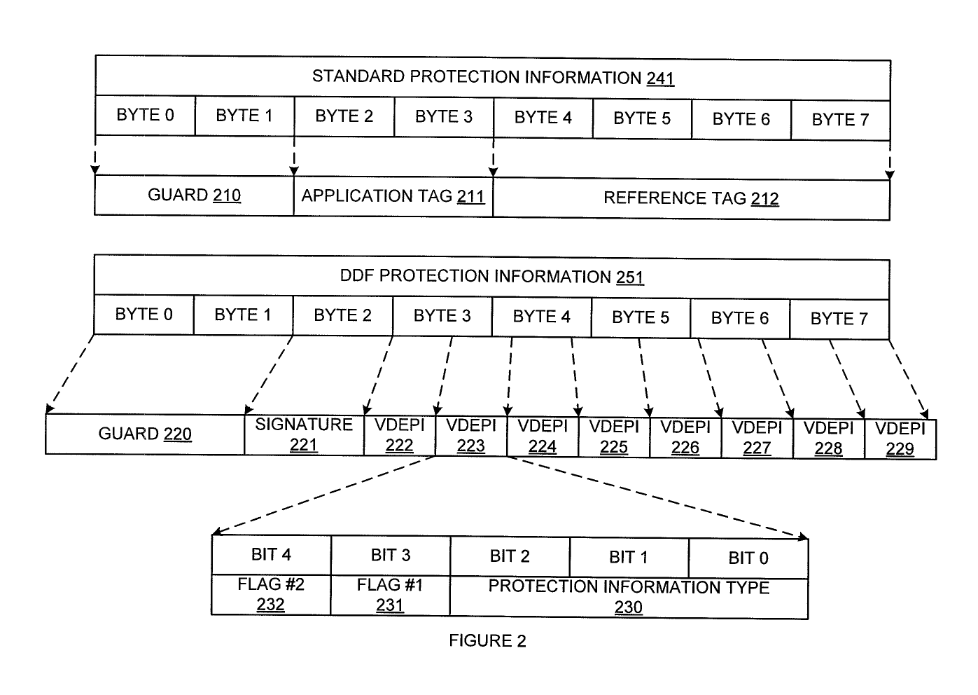

FIG. 2 is a diagram illustrating protection information fields and an example of encoded configuration information fields. In FIG. 2, standard protection information 241 is illustrated. The standard protection information format and contents are detailed in the SBC-3 standard referenced herein. As illustrated in FIG. 2, standard protection information 241 includes eight bytes of information. These eight bytes of standard protection information 241 include two bytes of a guard field 210, two bytes of an application tag field 211, and four bytes of reference tag field 212. In FIG. 2, example DDF protection information 251 is also illustrated. DDF protection information 251 includes eight bytes of information so it corresponds to, and can be stored in, storage intended for standard protection information 241. These eight bytes of DDF protection information 251 include two bytes of a guard field 220, one byte of a signature field, and 8 5-bit fields of virtual disk entry protection information (VDEPI) fields 222-229. The five bits of each VDEPI field 222-229 include three bits to specify the protection information type, one bit to specify a first flag (flag #1), and one bit to specify a second flag (flag #2). The three bits specifying the protection information type can correspond to the SCSI protection information type associated with the corresponding virtual volume. Valid types SCSI protection information have been discussed herein (e.g., Type-0, Type-1, etc.). The first flag can specify whether the application tag for the associated virtual volume is specified by the user, or matches the logical drive. The second flag can specify whether the application tag is specified by the first flag, or whether the application tag is zero (0).

For the arbitrary example DDF protection information 251 illustrated in FIG. 2, it is assumed that physical drive 130 supports the DPICZ bit. Thus, the guard field contains the 16-bit CRC of the first 512-bytes of each block. The first byte of the application tag is used as a non-all 1's (i.e., a non-0xFF) signature. With a maximum of 8 virtual disk entry (VDE) records per block, the remaining 40 bits are split into eight 5-bit sections describing the protection information properties (a.k.a., encoded configuration information) of the corresponding virtual disk records.

When non-protection information aware controller attempts to import a virtual disk from DDF data area 150 on physical disk 130, the non-protection information aware controller will use only non-32 byte SCSI commands and thus cannot read the protection information fields stored in the DDF protection information area 151 fields. When the non-protection information aware controller writes new protection information fields to the DDF protection information area 151, it will write 0xFF to the bytes in the application and reference tags. Upon importing physical disk 130 to a protection information capable system (e.g., storage system 100), a signature for the encoding illustrated in FIG. 2 may be unrecognized. In this case, the virtual disks associated with the DDF data structures stored in DDF data area 150 on physical disk 130 will be treated as not having protection information. In other words, the virtual disks will be treated as having Type-0 protection information.

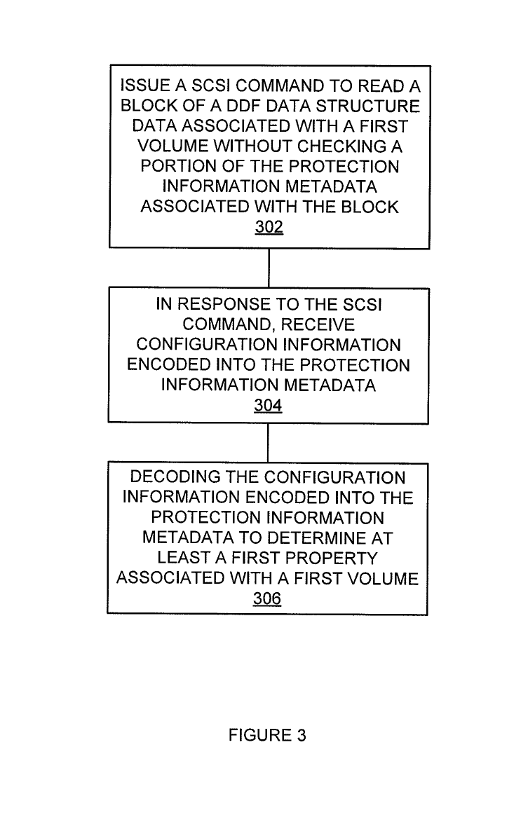

FIG. 3 is a flowchart illustrating a method of using information stored in protection information fields. The steps illustrated in FIG. 3 may be performed by one or more elements of storage system 100. A SCSI command is issued to read a block of DDF data structure data associated with a first volume without checking a portion of the protection information metadata associated with the block (302). For example, host 110 may issue a SCSI command with 011b or 100b for the 3-bits of RDPROTECT, WRPROTECT, ORPROTECT, or VRPROTECT (as appropriate) to physical disk 130. The SCSI command with either of these values will cause physical disk 130 to read a block of data from DDF data area 150 without checking at least part of the protection information fields stored in DDF protection information area 151.

In response to the SCSI command, configuration information encoded into the protection information metadata is received (304). For example, in response to the SCSI command with 011b or 100b for the 3-bits of RDPROTECT, WRPROTECT, ORPROTECT, or VRPROTECT (as appropriate), physical disk 130 may supply host 110 with configuration information that has been encoded into one or more of the protection information fields stored in DDF protection information area 151. In response to the SCSI command, physical disk 130 may supply host 110 with configuration information that has been encoded according to the format for the protection information fields illustrated in FIG. 2.

The configuration information encoded into the protection information metadata is decoded to determine at least a first property associated with a first volume (306). For example, host 110 may decode the encoded configuration information received from physical disk 130. The decoded configuration information may specify properties associated with a virtual volume described in data structures stored in DDF data area 150. The decoded configuration information may specify properties associated with physical disk 130. For example, the configuration information may indicate whether protection information is use by the first volume. In another example, the configuration information may indicate a signature value that indicates a format for a remaining portion of the protection information metadata. In another example, the configuration information may indicate that a reference tag included in the protection information metadata holds at least a portion of a logical block address associated with the first block. In another example, the configuration information may indicate that the application tag included in the protection information metadata holds a logical volume indicator associated with a physical mass storage device storing the first block. In other words, the configuration information may indicate that the application tag included in the protection information stored in DDF protection information area 151 holds a logical volume indicator associated with physical drive 130.

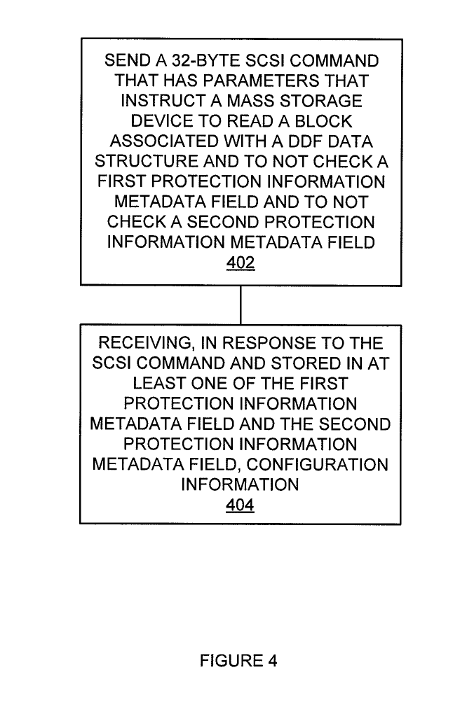

FIG. 4 is a flowchart illustrating a method of detecting protection information. The steps illustrated in FIG. 4 may be performed by one or more elements of storage system 100. A 32-byte SCSI command that has parameters that instruct a mass storage device to read a block associated with a DDF data structure and to not check a first protection information metadata filed and to not check a second protection information metadata field is sent (402). For example, host 110 may issue a SCSI command with 011b or 100b for the 3-bits of RDPROTECT, WRPROTECT, ORPROTECT, or VRPROTECT (as appropriate) to physical disk 130. The SCSI command with either of these values will cause physical disk 130 to read a block of data from DDF data area 150 without checking the reference tag field and application tag filed portions of the protection information fields stored in DDF protection information area 151.

In response to the SCSI command, configuration information stored in at least one of the first protection information metadata field and the second protection information metadata field is received (404). For example, host 110 may receive from physical disk 130, configuration information stored in at least one of the reference tag field and application tag filed portions of the protection information fields stored in DDF protection information area 151.

In an embodiment, the configuration information indicates whether protection information on the mass storage device is usable. For example, if a signature portion of the configuration information is unrecognized by host 110, then this may indicate to host 110 whether the protection information on physical disk 130 is usable.

The configuration information may indicate a usage of the first protection information metadata field and the second protection information metadata field in blocks associated with a volume associated with the DDF data structure stored at least in part by the block associated with a data disk format data structure. For example, a signature portion of the configuration information may indicate to host 110 how to decode and/or use the reference tag field and application tag filed portions of the protection information fields stored in DDF protection information area 151.

The configuration information may describe protection information properties of corresponding virtual disk entries in the DDF data structure. For example, the configuration information stored in DDF protection information area 151 may describe protection information properties that are associated with virtual disk entries described in data from DDF data area 150. In another example, the protection information properties may indicate whether an application tag metadata field of protection information of the corresponding virtual is usable. The protection information properties can also indicate a SCSI protection information type.

The methods, systems, hosts, networks, interconnections, and controllers described above may be implemented with, contain, or be executed by one or more computer systems. The methods described above may also be stored on a non-transitory computer readable medium. Many of the elements of storage system 100 may be, comprise, or include computers systems. This includes, but is not limited to: host 110, intermediate storage interconnection 115, controller 135, and/or other elements of physical drive 130.

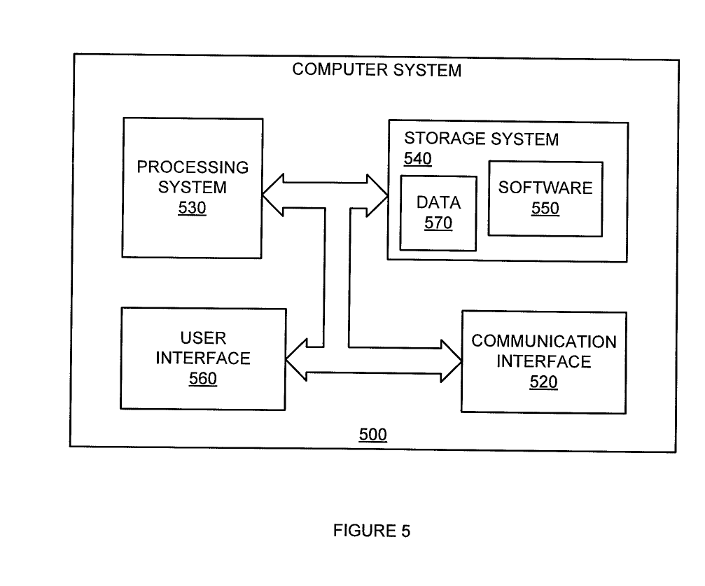

FIG. 5 illustrates a block diagram of a computer system. Computer system 500 includes communication interface 520, processing system 530, storage system 540, and user interface 560. Processing system 530 is operatively coupled to storage system 540. Storage system 540 stores software 550 and data 570. Processing system 530 is operatively coupled to communication interface 520 and user interface 560. Computer system 500 may comprise a programmed general-purpose computer. Computer system 500 may include a microprocessor. Computer system 500 may comprise programmable or special purpose circuitry. Computer system 500 may be distributed among multiple devices, processors, storage, and/or interfaces that together comprise elements 520-570.

Communication interface 520 may comprise a network interface, modem, port, bus, link, transceiver, or other communication device. Communication interface 520 may be distributed among multiple communication devices. Processing system 530 may comprise a microprocessor, microcontroller, logic circuit, or other processing device. Processing system 530 may be distributed among multiple processing devices. User interface 560 may comprise a keyboard, mouse, voice recognition interface, microphone and speakers, graphical display, touch screen, or other type of user interface device. User interface 560 may be distributed among multiple interface devices. Storage system 540 may comprise a disk, tape, integrated circuit, RAM, ROM, network storage, server, or other memory function. Storage system 540 may be a computer readable medium. Storage system 540 may be distributed among multiple memory devices.

Processing system 530 retrieves and executes software 550 from storage system 540. Processing system 530 may retrieve and store data 570. Processing system 530 may also retrieve and store data via communication interface 520. Processing system 530 may create or modify software 550 or data 570 to achieve a tangible result. Processing system 530 may control communication interface 520 or user interface 560 to achieve a tangible result. Processing system 530 may retrieve and execute remotely stored software via communication interface 520.

Software 550 and remotely stored software may comprise an operating system, utilities, drivers, networking software, and other software typically executed by a computer system. Software 550 may comprise an application program, applet, firmware, or other form of machine-readable processing instructions typically executed by a computer system. When executed by processing system 530, software 550 or remotely stored software may direct computer system 500 to operate as described herein.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of using information stored in protection information fields of mass storage device blocks that store data disk format (DDF) data structures, comprising:
issuing a SCSI command to the mass storage device to read a first block that stores a first portion of a DDF data structure associated with at least a first volume, the SCSI command instructing the mass storage device not to check at least a first portion of protection information metadata associated with the first block;
in response to the SCSI command, receiving configuration information encoded into the protection information metadata; and,
decoding the configuration information encoded into the protection information metadata to determine at least a first property associated with the at least first volume.

2. The method of claim 1, wherein the first property indicates whether protection information is in use by the at least first volume.

3. The method of claim 1, wherein the first property indicates a signature value that indicates a format for a remaining portion of the protection information metadata.

4. The method of claim 1, wherein the protection information metadata includes an application tag.

5. The method of claim 1, wherein the protection information metadata includes a reference tag.

6. The method of claim 1, wherein the at least first property indicates that a reference tag included in the protection information metadata holds at least a portion of a logical block address associated with the first block.

7. The method of claim 1, wherein the at least first property indicates that an application tag included in the protection information metadata holds a logical volume indicator associated with a physical mass storage device storing the first block.

8. A method of detecting protection information, comprising:
sending a 32-byte SCSI command to a mass storage device, the SCSI command having parameters that instruct the mass storage device to read a block associated with a data disk format data structure, the parameters also instructing the mass storage device not to check a first protection information metadata field and a second protection information metadata field, the data disk format (DDF) data structure describing how data is formatted across a plurality of disks in a RAID group; and,
receiving, in response to the SCSI command and stored in at least one of the first protection information metadata field and the second protection information metadata field, configuration information.

9. The method of claim 8, wherein the configuration information indicates whether protection information on the mass storage device is usable.

10. The method of claim 8, wherein the configuration information indicates a usage of the first protection information metadata field and the second protection information metadata field in blocks associated with a volume associated with the DDF data structure stored at least in part by the block associated with a data disk format data structure.

11. The method of claim 8, wherein the configuration information indicates a signature value that indicates a format for a remaining portion of the configuration information.

12. The method of claim 8, wherein the configuration information describes protection information properties of corresponding virtual disk entries in the DDF data structure.

13. The method of claim 12, wherein the protection information properties indicates whether an application tag metadata field of protection information of the corresponding virtual is usable.

14. The method of claim 13, wherein the protection information properties indicate a SCSI protection information type.

15. A computer readable medium having instructions stored thereon for using information stored in protection information fields of mass storage device blocks that store data disk format (DDF) data structures that, when executed by a computer, at least instruct the computer to:
issue a SCSI command to the mass storage device to read a first block that stores a first portion of a DDF data structure associated with at least a first volume, the SCSI command instructing the mass storage device not to check at least a first portion of protection information metadata associated with the first block;
in response to the SCSI command, receive configuration information encoded into the protection information metadata; and,
decode the configuration information encoded into the protection information metadata to determine at least a first property associated with the at least first volume.

16. The medium of claim 15, wherein the first property indicates whether protection information is in use by the at least first volume.

17. The medium of claim 15, wherein the first property indicates a signature value that indicates a format for a remaining portion of the protection information metadata.

18. The medium of claim 15, wherein the protection information metadata includes an application tag.

19. The medium of claim 15, wherein the protection information metadata includes a reference tag.

20. The method of claim 15, wherein the protection information metadata describes protection information properties of corresponding virtual disk entries in the DDF data structure.
